(19) United States
(12) Patent Application Publication
(10) Pub. No.: US 2016/0102196 A1
(43) Pub. Date: Apr. 14, 2016

(54) Plastic Corrugation

(71) Applicant: ORBIS Corporation, Oconomowoc, WI (US)

(72) Inventor: David Dodd, Sun Prairie, WI (US)

(21) Appl. No.: 14/865,653

(22) Filed: Sep. 25, 2015

Related U.S. Application Data
(60) Provisional application No. 62/062,481, filed on Oct. 10, 2014.

(51) Int. Cl. C08L 23/12

(52) U.S. Cl. CPC C08L 23/12

(57) ABSTRACT

A corrugated plastic sheet is provided having two outer sheets and internal ribs. The ratio of the thicknesses between each outer sheet and a rib is approximately 2:1. This ratio can be adjusted so that the upper and lower sheets are thicker than the thickness of the ribs. The die itself does not need to be changed. Rather, the die settings are merely adjusted.

### CROSS-REFERENCE TO RELATED APPLICATIONS

The present application claims the benefit of U.S. Provisional Application No. 62/062,481, filed Oct. 10, 2014, the contents of which are incorporated herein by reference.

### FEDERALLY SPONSORED RESEARCH OR DEVELOPMENT

Not applicable.

### FIELD OF THE INVENTION

The present invention generally relates to reusable plastic corrugations made primarily for containers.

### BACKGROUND OF THE INVENTION

Reusable plastic packaging has in recent years been used to store and transport all manner of goods and materials via air, highway, and rail. Such goods and materials run the gamut, including general merchandise, health and beauty aids, automotive parts, beverage, bakery, pharmaceuticals, and food products.

Reusable packaging typically lasts for multiple trips making it more cost effective than wood fiber or paperboard corrugated or other disposable packaging, which is typically discarded after a single use. Plastic packaging is both reusable and recyclable, and therefore, environmentally friendly.

Accordingly, Assignee of the present development, Orbis Corporation has been developing and refining plastic corrugated containers. Examples of recent Orbis Corporation developments are described in U.S. patent application Ser. No. 14/265,977, filed Apr. 30, 2014, titled “Plastic Corrugated Container with Sealed Edges,” U.S. patent application Ser. No. 14/265,935, filed Apr. 30, 2014, titled “Plastic Corrugated Container with Manufacturer's Joint Adding Zero Extra Thickness,” U.S. Pat. No. 8,864,017 issued Oct. 21, 2014, titled “Plastic Corrugated Container with Improved Fold Lines and Method and Apparatus for Making Same,” and U.S. Patent Application No. 61/920,570, filed Dec. 24, 2013, titled “Plastic Corrugated Manufacturing Process,” all incorporated herein by reference.

Corrugated plastic, sometimes called “coroplast,” relates to extruded double-walled plastic sheets, or liners, produced from polypropylene or polyethylene resin. Corrugated plastic sheets have a generally similar construction to corrugated paperboard. There are two layers of sheets or skins connected by flutes disposed and connected therebetween to form the corrugated sheet. As opposed to the flutes being undulating waves as they are in paperboard corrugations, the flutes in plastic corrugations are more like ribs.

The corrugated sheets can be transparent to allow light transmission, or they can be custom colored or translucent to signify an owner or manufacturer, or to block the transmission of light. The space between the outer skins act as an insulator. Graphics can also be applied to the outer surfaces and inner surfaces of the outer layers.

Chemically, corrugated plastic sheets are inert, with a neutral pH factor. At regular temperatures most oils, solvents and water have no effect, allowing the corriboard to perform under adverse weather conditions or as a product component exposed to harsh chemicals. Standard corrugated plastic sheets can be modified with additives, which are melt-blended into the sheet to meet specific needs of the end user. Special products that require additives can include: ultra-violet protection, anti-static, flame retardant, custom colors, corrosive inhibitors, static-dissipative, among others.

The Wiley Encyclopedia in Packaging Technology)(“Boxes, Corrugated” in The Wiley Encyclopedia of Packaging Technology, eds. Brody A and Marsh K, 2nd ed, John Wiley & Sons, New York) identifies the following standard flute designations used in the United States for paperboard corrugations:

| Flute | Flutes per | Flute thick- | Flutes per | Flute thick- |
|---|---|---|---|---|
| Designation | linear foot | ness (in) | linear meter | ness (mm) |
| A flute | 33 +/− 3 | 3/16 | 108 +/− 10 | 4.8 |
| B flute | 47 +/− 3 | ⅛ | 154 +/− 10 | 3.2 |
| C flute | 39 +/− 3 | 5/32 | 128 +/− 10 | 4.0 |
| E flute | 90 +/− 4 | 1/16 | 295 +/− 13 | 1.6 |
| F flute | 128 +/− 4 | 1/32 | 420 +/− 13 | 0.8 |

The present invention is provided as an improvement upon existing plastic corrugations. The present development is more specifically an improvement to making the plastic corrugation sheets and to the resulting product. It has improved puncture and tear resistance and has been found to be more durable. The board stiffness can be varied without changing the basis weight. A full discussion of the features and advantages of the present invention is deferred to the following detailed description, which proceeds with reference to the accompanying drawings.

### SUMMARY OF THE INVENTION

The present invention relates to a reusable corrugated plastic sheet primarily for containers, e.g., boxes. The corrugated sheets of extruded plastic are formed into flat sheets or blanks. The extruded plastic includes a first outer layer, a second outer layer and a plurality of flutes in the form of ribs between the first outer layer and second outer layer. Very generally, the blank is then converted with fold lines and folded. Fold lines are designed to include both scored portions (i.e., partially crushed) and welded portions (e.g., heat welded) with portions being welded together. The scored portions also allow for folding and allow the memory of the plastic to recover over time to enable flaps to again become coplanar with the respective side or end walls after use. This facilitates the reuse of the container after a first (or subsequent) use because the package erecting and packing machinery requires the containers to be straight.

Additionally, the blank can be formed to have better and smoother outer edges. This can be accomplished after or part of an extruding process by pressing a generally C-shaped hot plate against the edges of the extruded sheet.

The blank can be further provided with connecting segments on either end of the blank having a reduced thickness. The connecting segments are used to connect the ends together to form a functional container. These connecting segments must be such that the partially broken down container would lay flat to be used with existing packaging equipment.

The above handling of the sheets or blanks is explained more fully in the Orbis applications identified above.

The present development is an improvement on making the plastic corrugation sheets and the resulting product. It has been found to have improved puncture and tear resistance and to be more durable, all without adding additional weight to the sheets. More particularly, it has been found to be more durable in cold conditions. Additionally, the board stiffness can be varied without changing the basis weight. The preferred ratio of approximately 2:1, outer skin thickness to internal ribs/flutes thickness, permits flexibility in construction. Thus, for example, the thinner flutes may be employed to reduce board stiffness. This may be important in using the boxes through automation. This can also change the beginning force that the scores need to counteract.

Other features and advantages of the invention will be apparent from the following specification taken in conjunction with the following Figures.

### BRIEF DESCRIPTION OF THE FIGURES

To understand the present invention, it will now be described by way of example, with reference to the accompanying Figures in which:

FIG. 1 is a side elevation view of a corrugation made in accordance with the teachings of the present invention; and,

FIG. 2 is schematic diagram of the extruder, die and adjustment control.

### DETAILED DESCRIPTION OF THE INVENTION

While this invention is susceptible of embodiments in many different forms, there is shown in the Figures, and will herein be described in detail, preferred embodiments of the invention with the understanding that the present disclosure is to be considered as an exemplification of the principles of the invention, and is not intended to limit the broad aspect of the invention to the embodiments illustrated.

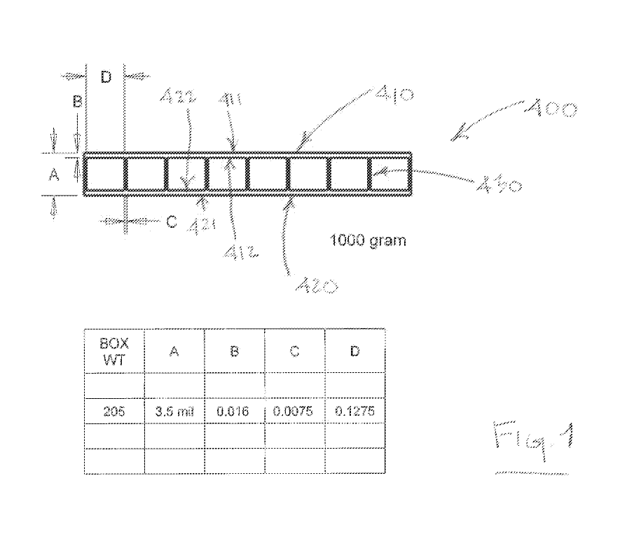

Referring to the drawings, in an embodiment of the present invention shown in FIG. 1, the side of a portion or segment of a corrugation sheet 400 is provided. It is made of plastic, specifically high density polypropylene. The extruded plastic includes a first outer layer 410, a second outer layer 420 and a plurality of flutes in the form of flutes or ribs 430 between the first outer layer 410 and second outer layer 420. Each outer layer 410,420 has an internal surface 411,421 and an external surface 412,422.

A corrugated blank (generally shown by segment 400) is typically formed as a single, integral sheet, preferably by an extrusion process. Plastic corrugated containers can be made to suit particular size, stiffness, resilience, and strength requirements by a variety of characteristics or parameters, such as the thickness of the first and second layers 410,420, the overall thickness of the sheet, the number of flutes or ribs 430, the plastic resin used, or other characteristics of the blank material. Typical ranges for such parameters include 67-100 flutes per foot, blank thickness of 2 to 10 mm, and plastic material density of 400 to 1,000 grams per square meter.

In the preferred embodiment, the thickness B of the first and second outer layers 410,420 is about 0.016 millimeters (mm), the substrate thickness A between the external surfaces 411,421 of the outer layers 410,420 is about 3.5 mm. The thickness C of the internal ribs 430 is about 0.0075 mm. And, the distance D between ribs 430 is about 0.120, or 100 flutes/ribs per foot. The plastic used has a plastic material density of 1,000 grams per square meter.

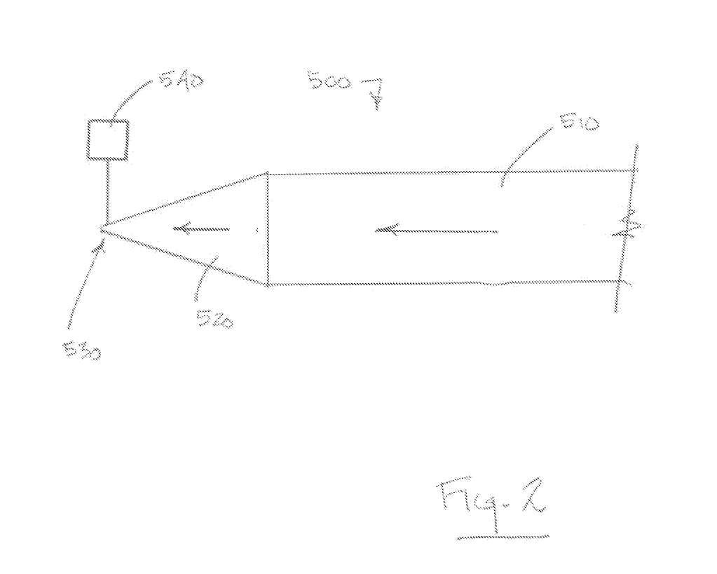

The corrugation is made using an extruder, generally shown in FIG. 2 at 500. The plastic material flows through the extruder 500 via a supply line 510 and a die 520 having an outlet 530. During construction, the top and bottom die lip bolts (schematically shown at 540) for the extruder's die 520 are opened more than for standard sheets to allow more material to flow into the skins, or first and second layers 410,420 and less in the ribs 430. For standard 3.5 mm sheets, the die lips are set to 0.60 mm. For the present 3.5 mm sheets 400, the die lips are set to 0.80 mm for 800 grams (per square meter) sheets and 0.90 mm for 1000 grams (per square meter) sheets. The restrictor bar bolts are adjusted accordingly for even weight distribution. The ideal is to have about a 2:1 skin to rib thickness and even weight distribution. (Here, thickness B (0.016) v. thickness C (0.0075 mm)).

One of the significant advantages in the present development is the die itself does not need to be changed. Rather, the die settings are merely adjusted. Commonly used corrugated plastic has a general ratio of 1:1 ratio of top or bottom sheet thickness to rib thickness. Here, that ratio can be adjusted so that the upper and lower sheets are thicker than the thickness of the ribs and can have a ratio of approximately 2:1.

It is recognized that the wall 430 thicknesses C of the rib can be varied. This is accomplished by changing the setting on the extruder, not the entire die of the extruder. Similarly, the thickness B of the outer skins 410,420 can be varied depending on properties desired in the finished product.

The corrugated plastic sheet is preferably polypropylene, or any thermoplastic, but most likely a polyolefin, with a substrate thickness A between 3 mm and 4.5 mm. The gram density of the sheet or substrate is preferably between 700 grams/meter² and 1200 grams/meter² with the preferred embodiment being in the range 800-1000 grams/meter², having a total thickness of 3.5 mm (substrate thickness A), made of polypropylene, and with an approximate 2:1 ratio between the outer sheet thickness 410,420 (thickness B) and the thickness of the flutes 430 (thickness C).

One of ordinary skill in the art would appreciate that the terms “first,” “second,” “upper,” “lower,” etc. are used for illustrative purposes only and are not intended to limit the embodiments in any way. The term “plurality” as used herein is intended to indicate any number greater than one, either disjunctively or conjunctively as necessary, up to an infinite number. The terms “joined,” “attached,” and/or “connected” as used herein are intended to put or bring two elements together so as to form a unit, and any number of elements, devices, fasteners, etc. may be provided between the joined, attached or connected elements unless otherwise specified by the use of the term “directly” and/or supported by the drawings.

While the specific embodiments have been illustrated and described, numerous modifications come to mind without significantly departing from the spirit of the invention and the scope of protection is only limited by the scope of the accompanying Claims.

We claim:

1. A corrugated substrate comprising:
at least two planar sheets substantially parallel to one another each having a first thickness;
a plurality of ribs disposed between the sheets, each rib having a second thickness;
the ratio of the first thickness to the second thickness being approximately 2:1; and, the substrate is plastic.

2. The corrugated substrate of claim 1 wherein the ribs are disposed perpendicular to the planar sheets.

3. The corrugated substrate of claim 1 wherein the substrate is a high density polypropylene.

4. The corrugated substrate of claim 1 wherein there are about 100 ribs per foot.

5. The corrugated substrate of claim 1 wherein the first thickness is about 0.016 millimeters and the second thickness is about 0.0075 millimeters.

6. The corrugated substrate of claim 1 wherein the substrate thickness is in the range of about 3 millimeters to 4.5 millimeters.

7. The corrugated substrate of claim 1 wherein the substrate thickness is about 3.5 millimeters.

8. The corrugated substrate of claim 6 wherein the approximate distance between each of the plurality of ribs is about 0.120 millimeters.

9. The corrugated substrate of claim 6 wherein the substrate has a plastic material density in the range of about 700 grams per square meter to about 1,200 grams per square meter.

10. The corrugated substrate of claim 6 wherein the substrate has a plastic material density in the range of about 800 grams per square meter to about 1,000 grams per square meter.

11. The corrugated substrate of claim 1 having a fold line.

12. The corrugated substrate of claim 11 wherein the substrate forms a box.
